(19) United States
(12) Patent Application Publication
(10) Pub. No.: US 2008/0195594 A1
(43) Pub. Date: Aug. 14, 2008

(54) Computerized Comprehensive Health Assessment and Physician Directed Systems

(76) Inventors: Sven W. Gerjets, Redondo Beach, CA (US); James J. Mahoney, Flower Mound, TX (US); Kyl L. Smith, Corinth, TX (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/596,317

(22) PCT Filed: May 11, 2005
(86) PCT No.: PCT/US2005/016331

§ 371 Date: Mar. 13, 2008

Related U.S. Application Data
(60) Provisional application No. 60/569,617, filed on May 11, 2004.

(51) Int. Cl. G06F 17/30

(52) U.S. Cl. 707/5; 707/E17.014

(57) ABSTRACT

The system and process of the present invention employs encrypted data input from both users and physicians to identify disturbances in human biologic function. Physical and metabolic characteristics, historical data and current symptoms are compiled through use of a computerized expert system that recognizes patterns predictive of metabolic dysfunction or insufficiency. Functional capabilities of all bodily systems are simultaneously evaluated at each input session through expert system analysis to create science-based remedial plans exemplifying methods of lifestyle alteration and biologic response modification through nutrition and other means. Enhancement of metabolic activity is presumed on the basis of improving symptom, metabolic, and laboratory scores. Lifestyle, fitness, nutritional, and dietary plans are formatted for uncomplicated implementation and professional guidance in applying all interventions to uniquely integrate the offerings of medical, healthcare and lifestyle professionals.

### FIELD OF INVENTION

The present invention relates to an automated computer system and process for collecting information to identify unique metabolic characteristics that may be exploited for the purposes of modification or enhancement of function through the creation of science based individualized lifestyle, fitness, dietary and nutrient consumption plans.

### BACKGROUND OF THE INVENTION

In the 1950's, pioneers in functional medicine began research in what was called molecular nutrition. These pioneers developed concepts of biochemical individuality and biomolecular psychiatry that investigated the integral relationships of nutrition and physiology.

Unfortunately today, most contemporary health care practitioners have little formal education in functional medicine and molecular or clinical nutrition. As a result, too few doctors recognize the connection between faulty nutrition and clinical disorders in their patients. Additionally, the process of addressing the relationship between nutrition and clinical disorders is burdensome as a result of the labor and time intensive tasks of evaluation, integration and implementation. While causal relationships between metabolic dysfunction, biochemical individuality and age-related diseases are now scientifically recognized and validated as being closely tied to lifestyle, environmental factors, and diets that provide inappropriate macro and micro nutritional constituents, the sheer volume of currently available peer-reviewed science has outstripped the typical consumer as well as physician's ability to implement lifestyle, fitness, dietary and nutritional modifications based on relevant, currently available scientific evidence.

As a result, incongruent advice and resultant confusion permeates the health, nutrition and preventive care industries regarding what, when and how to implement proper age and gender specific diet, nutrition, exercise and remedial lifestyle recommendations. Moreover, the health care industry is inundated with conflicting opinions engendering inconsistent advice regarding diet, health, lifestyle, exercise, and disease prevention strategies for various populations.

The nutritional industry offers a widely divergent array of products that when utilized, separately or in combination, may or may not be beneficial to an individual based on their age, gender, genetic, environmental and lifestyle factors, formulation, and method of administration. Furthermore, many consumers are not aware of the potential overlap or superfluous combinations of ingredients in their supplement programs that may combine to provide nutritional ingredient amounts in excess of what is clinically relevant, validated, or necessary for healthy support.

Most consumers do not discuss nutritional support products with their primary health care providers and therefore, miss the positive synergy that could occur as the result of a properly implemented, integrated nutritional/medical plan.

Beyond these factors, efficacious management of an individual's healthcare needs should include remedial measures associated with functional medicine. Current peer-reviewed science validates the following four factors that make a nutritional approach to functional medicine a foundational aspect of healthcare today: (1) nutrition is an environmental factor that influences gene expression and phenotype in each individual, (2) nutrients act as important biological response modifiers and control/regulate function of tissues, glands, organs and systems throughout the body, (3) the molecular environment of the body depends on the interaction of an individual's genes with macronutrients, micronutrients, and conditionally essential nutrients, and (4) diseases such as cardiac disease, adult-onset diabetes, arthritis, digestive disorders, loss of cognitive function and many forms of cancer are often the result of an amalgamation of multiple factors including nutritional under-consumption, poor dietary, lifestyle, fitness and environmental choices.

### SUMMARY OF THE INVENTION

The present invention focuses on assessment and intervention related to the improvement of physiological, cognitive/emotional, and physical functioning as these areas relate foundationally to lifestyle, fitness, nutrition and dietary factors. The present invention provides a unique computerized comprehensive health assessment and physician directed system that integrates age and gender specific contemporary scientific and clinical data, amalgamated with an individuals distinctive history, metabolic function, biochemical individuality, symptomotology, genetic, lifestyle factors as well as other health variables. This information is then assembled to provide easy access to objective, scientifically validated and customized health information based on nutritional functional needs. The system encourages as well as improves the efficiency of communication between consumers and health care providers and thereby promotes an integrated therapeutic approach to functional and preventive medicine. A goal of the present invention is to give individuals the tools that will reduce long-range disease risk and increase energy, vitality, and well-being.

In order to determine and provide relevant and suitable dietary, nutritional, lifestyle and exercise information based on gender, age, genetic variables, biochemical individuality, metabolic function and dysfunction, organ, glandular, system support, symptom remediation and other salient factors based on competent and reliable scientific evidence, this system routinely engages an electronic literature search utilizing the extensive “PubMed” electronic database of the National Library of Medicine i.e., http://www.ncbi.nlm.nih.gov/entrez/query. fcgi?db=PubMed. The “PubMed” database includes citations of over 10,000,000 scientific articles published in over 4,000 journals worldwide. In addition, published texts are utilized and, when appropriate, secondary citations mentioned in published articles and book chapters.

The present invention compiles and implements such scientific information culled from a wide selection of data points including relevant epidemiological studies, double-blind placebo controlled trials demonstrating efficacy of a given ingredient at a specific dose for the majority of individuals within a certain population, as well as practical clinical data. This information is compiled to arrive at nutritional, dietary, exercise and lifestyle plans that are customized for an individual's unique needs based on the input of specific variables as described herein. The end result is a scientifically validated, customized, accurately dosed plan for a given individual based on gender, age, metabolic function, biochemical individuality, symptoms, lifestyle, and other factors regarding health and wellness.

To achieve these and other advantages and in accordance with the purpose of the inventions, as embodied and broadly described, the present invention provides a method for the creation of science-based individualized life plans including accessing a secure website and entering data through the website into a correlation database. Applying correlation rules to the data stored in the correlation database to obtain functional area scores which are outputted into a functional area score database for storage. Intelligent rules are subsequently applied to the functional area scores stored in the functional area score database to retrieve content data from a report content database. The content data is sent to a plurality of dynamic report generators to create content specific reports that are dynamically assembled from the plurality of content specific reports for viewing. The entered data may be generated by an individual requesting the science-based individualized life plans and by individuals associated with the first individual.

In another aspect of the present invention, a health evaluation system includes a computer with an accessible memory. A file including personal data as profiles for a first individual may be stored in the memory. The system includes an interface device for accessing the file stored in the memory by the first individual and an expert evaluation application applies correlation rules to the personal data and subsequently applies intelligent rules for determining life plans of the first individual. The interface device also may include accessing the file and storing medical data by a set of second individuals associated with the first individual, and subsequent application of the correlation rules to the medical data. Additional intelligent rules may be dynamically layered upon the outcome of previous rules applied to the data.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the inventions.

FIG. 1 is a visual overview of a representative process flow of the system of the present invention.

FIG. 2 is a visual overview of a representative consumer expert system engine of the present invention.

FIG. 3 is a visual overview of a representative consumer user experience when utilizing the system of the present invention.

FIG. 4 is a visual overview of a representative clinical user experience when utilizing the system of the present invention.

FIG. 5 is a visual overview of a representative clinical expert system engine of the present invention.

### DETAILED DESCRIPTION OF THE INVENTION

Reference will now be made in detail to the preferred embodiments of the present invention, examples of which are illustrated in the accompanying drawings.

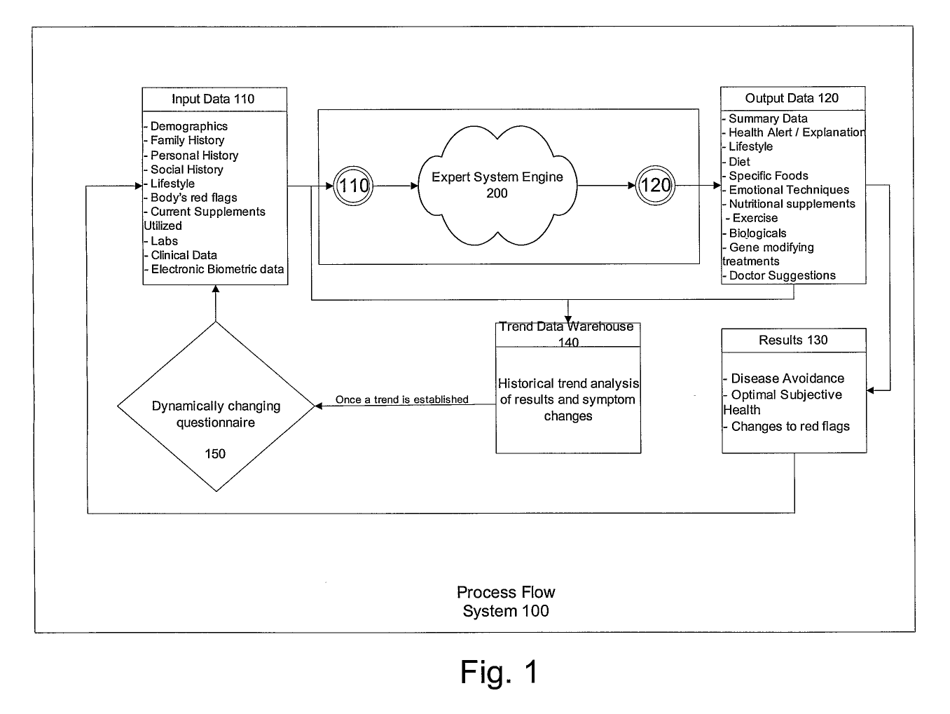

FIGS. 1-5 illustrate the preferred embodiments. In particular, FIG. 1 illustrates a visual overview of a process flow system 100 of the present invention. The system 100 integrates input data 110 from various sources. As shown in FIG. 1, input data 110 may be input directly from an interface device (not shown) by a user, a clinician, or a laboratory. A secure website may be accessed by the interface device through a socket of a secure encrypted server. Once the website is accessed, the user may be presented with a set of dynamically changing questions that will elicit particular input data 110. The types of input data 110 sought include but are not limited to:
Demographics—information that distinguishes a user including data points like age, weight, height, gender etc.
Family History—information pertaining to historical family environmental, medical, physiological, and/or psychological conditions.
Personal History—information pertaining to historical, personal, environmental, medical, physiological, and/or psychological conditions.
Social History—information regarding specific socio-environmental, sociological, and various social conditions that a person currently is, or has been exposed to in the past.
Current Supplements Utilized—the system allows users to select supplements from the system that are currently being utilized.
Lifestyle—information that pertains to a person's habitual lifestyle patterns including, but not limited to habitual thoughts and mental outlook, exercise, fitness, eating habits, smoking habits, and alcohol consumption etc.
Body's Red Flags—information regarding a person's perceived and objective measures of well being including emotional, global and specific physical, and global and specific mental measures.
Oriental Medicine Biopsychotype—physical characteristics and behavioral patterns suggest specific organ system dysfunction and failure along predictable lines according to well-documented principles of Eastern medicine. The system identifies these patterns and directs users and physicians to scrutinize these specific organ systems for their possible contribution to health diminishment.

In addition to input data 110 entered by the user, the system 100 is capable of utilizing input data 110 from clinical examination procedures and laboratory studies. Clinical and laboratory data also may be input through a secure socket connection of the secure server or through an electronic data interface with a laboratory or clinic. Clinical data is defined as any information gathered by all means during a direct encounter with the client present. Laboratory data includes any process of collecting and assessing biochemical metabolites, markers, laboratory values, and information generated from analytical data including, but not limited to the following:
Salivary/pH tests
Blood/blood plasma/blood spot tests
Urinary tests
Stool samples
Caliper readings

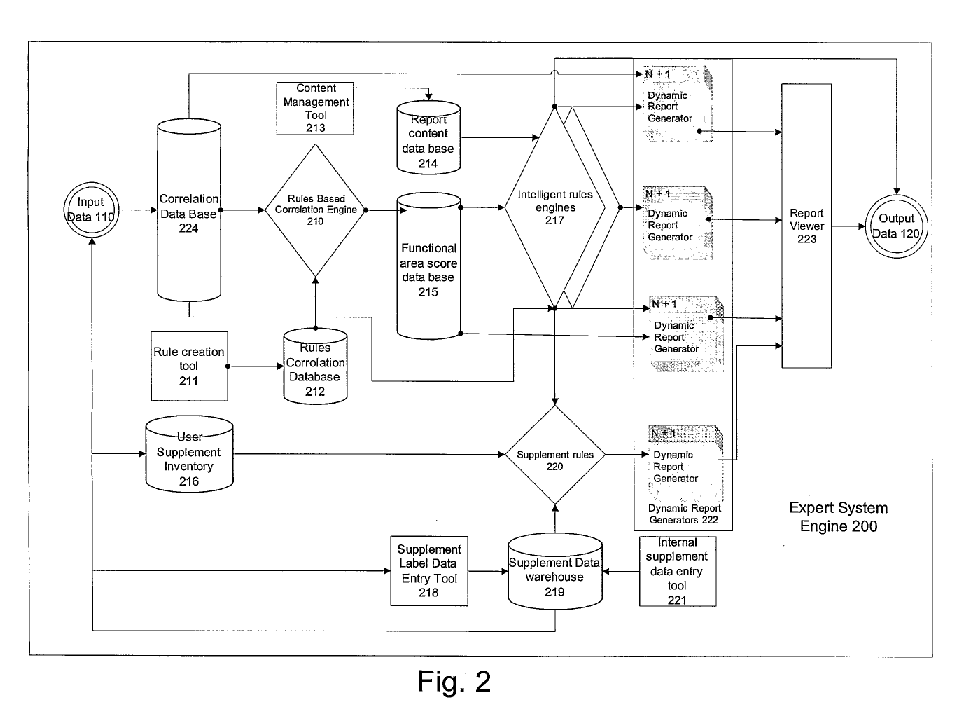

In addition to input data 110 mentioned above, the system 100 is capable of utilizing input data 110 from biometric measurement devices. Biometric data may include, but is not limited to: EKG data; EEG data; biometric scan data, digitized image data, electro magnetic feedback reader data, and electronic energy flow detection device data. All input data 110 is entered into a correlation database 224 of an expert system engine 200, as shown in FIG. 2.

FIG. 1 also shows output data 120 in the process flow system 100. The output data 120 may be utilized to improve quality of life and genetic expression. A goal of the system is to modify the functional genetic expression evidenced through improved laboratory parameters, sense of well-being, and objective physical and behavioral parameters. Output data 120 may include, but is not limited to:
Lifestyle Plan—customized lifestyle tips shown to address pertinent issues the user is facing.
Precision Fitness Plan—stretching, cardiovascular, and resistance training plans specifically designed according to the users exercise history, ability, and goals. Maximal and training heart rate, duration, method, type of exercise, and precise rest periods are among the essential components that produce benefit in this plan.
Precision Eating Plan—an eating plan that determines the particular carbohydrate to protein ratio for the user determined by calculation of specific inputs the user provided the system. The eating plan uses different foods and feeding schedules to maximize endogenous homeostatic control on multiple levels.
Nutrition Plan—an individualized compilation of foods to eat that will benefit the individual as well as a compilation of foods to avoid due to their negative impact on digestion, physiology, symptoms or digestive/allergic properties is a significant contributor to the effect of the plan. Blood type, allergy, underlying functional challenges and food preferences are integrated into the system.
Nutritional Supplements Plan—function-enhancing and supporting nutrients and agents targeted to a unique profile (individually and combined in defined proportions).
Nutritional Supplement Inventory Data—the ingredients in each supplement that the user is currently consuming is provided. These ingredients are compared with independently lab certified or otherwise third-party verified supplement data. The data provides specific information allowing the user to make an informed decision regarding the continuation of specific supplements the user is currently taking, or make an informed decision regarding the discontinuation of specific supplements that are no longer necessary, as well as verify the importance of additional supplements that may be added to establish or more thoroughly complete the clinical and peer-reviewed observations of the system.
Precision Emotional Repair Kit Plan—using well-established methods of distraction (stretching and other physical activity) from a troubling emotion-evoking stimulus (i.e., the thought of spiders), the user participates in precision emotional repair by speaking affirmations that are targeted to the specific fear as well as other emotions that are likely to be present based on input data 110 derived from the questionnaire. These areas of emotional need are largely derived from a biopsychotype model of oriental medicine in addition to self-reported areas of need by the user.
Doctor's Suggestions—information includes additional supplements, lab tests, and therapies designed to give the user's physician a variety of doctor assisted remedies or methodologies to more accurately address the user's needs.
Drugs and Pharmaceutical Preparations.
Biologicals—vaccines and sera.
Gene modifying treatments.
Various physical, emotional, energetic, and mental therapies.

The process flow system 100 of FIG. 1 also shows results 130. The results 130 represent measurable or perceived changes in the user after implementing one or more plans or utilizing the information produced in output data 120 to initiate healthful changes in indicated areas. The results 130 which may include areas involving e.g., disease avoidance, changes in the body's red flags, and optimal subjective health are entered into a second round of input data 110 provided by the user. That is, the results 130 are not considered until the user enters input data 110 into the process flow system 100 a second time.

The new input data 110 corresponding to the entered results 130 are stored in a trend data warehouse 140. Output data 120 generated by the expert system engine 200 is also stored in the trend data warehouse 140.

The trend data warehouse 140 allows the results 130 (via input data 110) and output data 120 to be stored and analyzed. The trend data stored in the trend data warehouse 140 is accessed by a dynamically changing questionnaire 150 that analyzes the trend data and dynamically changes the questions presented to the user the next time the user accesses the process flow system 100. The dynamically changed questions may be more specific or narrowly focused questions because of the historical trends analysis.

For example, when the results 130 indicate a negative change to a specific area, the dynamically changing questionnaire 150 will request more information of the user about the particular functional area. Thus, the negative change will ultimately generate more specific information for the user allowing them to focus on the area of particular concern. The trend data also can be utilized to generate content into the dynamically changing questionnaire 150 or directly into the correlation database 110 as a dynamic input device.

The process flow system 100 is a reoccurring process where the user has the ability to utilize the system 100 on a regular basis reentering input data 110 and generating a new set of output data 120 containing information specific to their current health situation. The data may be stored and trended allowing the process to be repeated, but with a slightly different focus and input data 110.

As shown in FIG. 2, an expert system engine 200 includes a number of databases, tools, rules engines, and content generators. The expert system engine 200 includes a correlation database 224 that stores all of the input data 110. As previously described, the input data 110 can be generated by the user, by a clinical examination, a laboratory study, or directly from biometric measurement devices.

The expert system engine 200 further includes a rule creation tool 211, which may be a simple graphic user interface to allow an expert system programmer or administrator to create a correlation rule. Each correlation rule created is capable of giving a positive, negative, or neutral value to the input data 110 for a particular functional area. A functional area is a monitored health factor related to the user's body chemistry, brain function, and immune system for example. More specifically, a functional area may be related to the user's thyroid performance, anxiety level, and allergies. For instance, if the user identifies a family history of cardiac disease as well as a lifestyle comprised of little exercise and high fat foods, the correlation rule will weigh these combined factors as highly negative, and factor in the remainder of the input data 110 to generate a functional area score for cardiac health. The functional area score is simply a numerical value given to the health factor after the correlation rule is applied to the input data 110. A highly negative functional area score for cardiac health may also impact the functional area score of another health factor and vice versa.

A rules correlation database 212 stores the correlation rules that relate to functional areas. The correlation rules give negative and positive weights to input data 110 that is relevant to a particular functional area. For example, if the user identifies a family history of cardiac disease (a negative indicator for cardiac health), but has a lifestyle comprised of frequent exercise and an appropriate diet (a positive indicator for cardiac health), the correlation rule will weigh these indicators against the rest of the input data 110 to generate a functional area score for cardiac health.

As shown in FIG. 2, a rules based correlation engine 210 applies a correlation rule to the input data 110 stored in the correlation database 224 and calculates the functional area score. Additionally, the rules based correlation engine 210 calculates a baseline value for each functional area. This baseline is the calculation of the highest possible positive value and the lowest possible negative value for each functional area. By comparing this baseline value to the calculated functional area score, the system is able to determine whether the positive or negative value is a priority set for the particular user. The rules based correlation engine 210 is also capable of utilizing already calculated functional area scores as an input for calculating subsequent functional area scores. For instance, a high functional area score for a particular function may impact another functional area driving its score higher or lower as appropriate.

The functional area score database 215 stores each calculated functional area score as well as the relevant baseline value for each functional area. This data is stored every time input data 110 is entered. The functional area scores also may be accessed during the trend analysis described above.

In FIG. 2, a report content database 214 is shown. The report content database 214 may include e.g., text and graphic content data that is entered by the administrator using a content management tool 213. The report content database 214 is a repository of substantive content that is drawn upon whenever intelligent rules engines 217 request content data. By utilizing the content management tool 213, the content data may develop in a logical fashion without the administrator having to understand the inter workings of the expert system engine 200.

The content data may be utilized in the dynamic creation of output data 120. The content data is created by the administrator to address specific functional area patterns or scenarios identified by the process flow system 100. The intelligent rules engines 217 retrieve content data (as text or graphical data) for assembly to create a completely customized report for the user based upon the input data 110, functional area scores, and historical trends analysis.

The intelligent rules engines 217 are a set of engines that are capable of executing rules against input data 110, functional area scores, and trend data to determine the content data for the user. The intelligent rules engines 217 are also capable of comparing the content data that has been extracted from the report content database 214 to ensure that duplicate content data is not presented to the user. The engines 217 are capable of ensuring that specific nutrient information, such as dosages, are listed at the level scientifically shown to address the most complex functional area. For example, if two functional areas are indicated as area of concern, both of which science indicates may be ameliorated with Vitamin C but at different dosages, the intelligent rules engines 217 will determine and present the dosage proven to address both functional areas appropriately.

The expert system engine 200 supports a very large number of intelligent rules engines 217. The number of intelligent rules engines 217 utilized may depend upon how detailed is the desired output data 120. For example, the typical report may utilize just a single intelligent rules engine 217 to analyze the functional area scores. When a more focused output data 120 is required, multiple intelligent rules engines 217 may be utilized to analyze input data 110 and functional area scores. The result being thorough yet narrowed output data 120 directed to the user.

As shown in FIG. 2, a user supplement inventory database 216 stores input data 110 relevant to supplements the user is currently taking. A supplement data warehouse 219 stores supplement data on supplements and their nutritional content. If the user is taking a supplement that is not found in the supplement data warehouse 219, the user has the ability to enter the label information of the supplement using a supplement label data entry tool 218.

Prior to becoming available, the stored user entered label information may be validated and approved by the administrator for accuracy. The supplement data warehouse also may be updated through an internal supplement data entry tool 221 by the administrator. Additionally, direct manufacturer data feeds as well as clinic data feeds may be used to populate the supplement data warehouse 219, but as with the supplement label data entry tool 218, the supplement data may be validated by an administrator prior to becoming available.

The supplement rules 220 query the supplement data warehouse for all supplements the user indicated as currently being taken. The supplement rules 220 analyzes all the nutrients identified by the user as being consumed, matching them to the nutrients in the supplements currently being taken. A report is created for the user providing information on what supplements the user may consider continuing, what supplements the user may choose to add, and what supplements may not be a priority or may be discontinued based on the functional area scores, input data 110, and physician recommendations.

FIG. 2 further shows a plurality of dynamic report generators 222 that assemble the content data to be utilized in the dynamic creation of output data 120. The dynamic report generators 222 dynamically build a graphically pleasing intelligible report for the user that details their individualized custom plans. The report is dynamically produced whenever the user requests it and is presented in a report viewer 223 e.g., a standard internet browser. The dynamic nature of the report generation allows the user to receive the latest up to date output data 120 every time the user requests to view their report. This is accomplished by using the stored input data 110 as well as the stored functional scores to compile a report using the latest updated content data from the report content database 214.

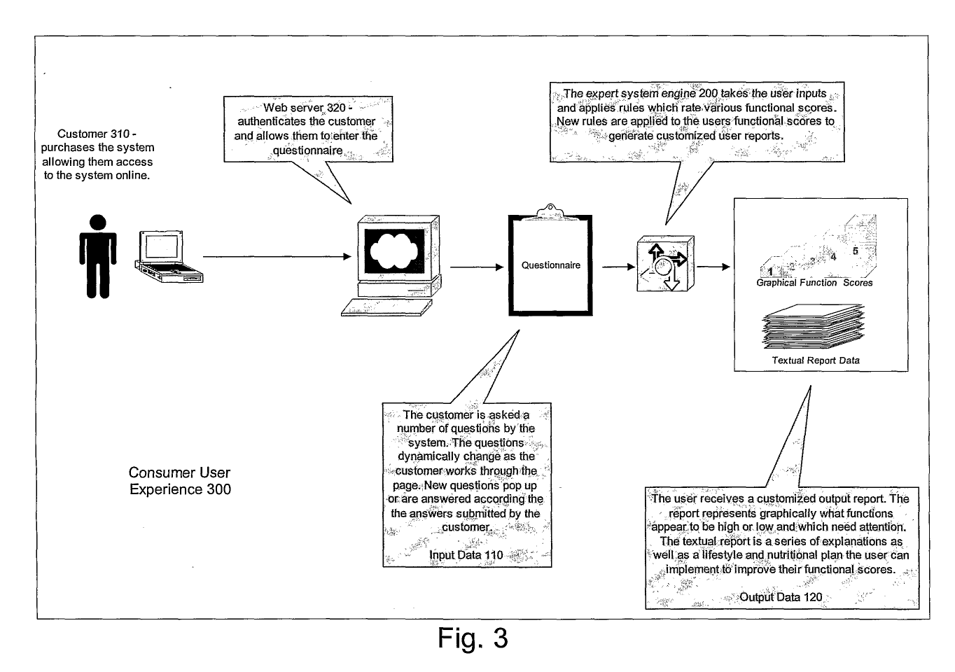

FIG. 3, shows a visual overview of a representative user experience when utilizing the direct customer embodiment of the present invention. Customer 310 may purchase access to the system and receive a user name and password that allows the user to connect via a secure socket connection to a web server 320. Residing on the web server 320, a graphic user interface allows the user to answer a dynamically changing questionnaire by entering input data 110. The input data 110 is transformed by the expert system engine 200 to create output data 120. The output data 120 is presented to the user in the form of an online report displayed by the web server 320 over the secure socket connection.

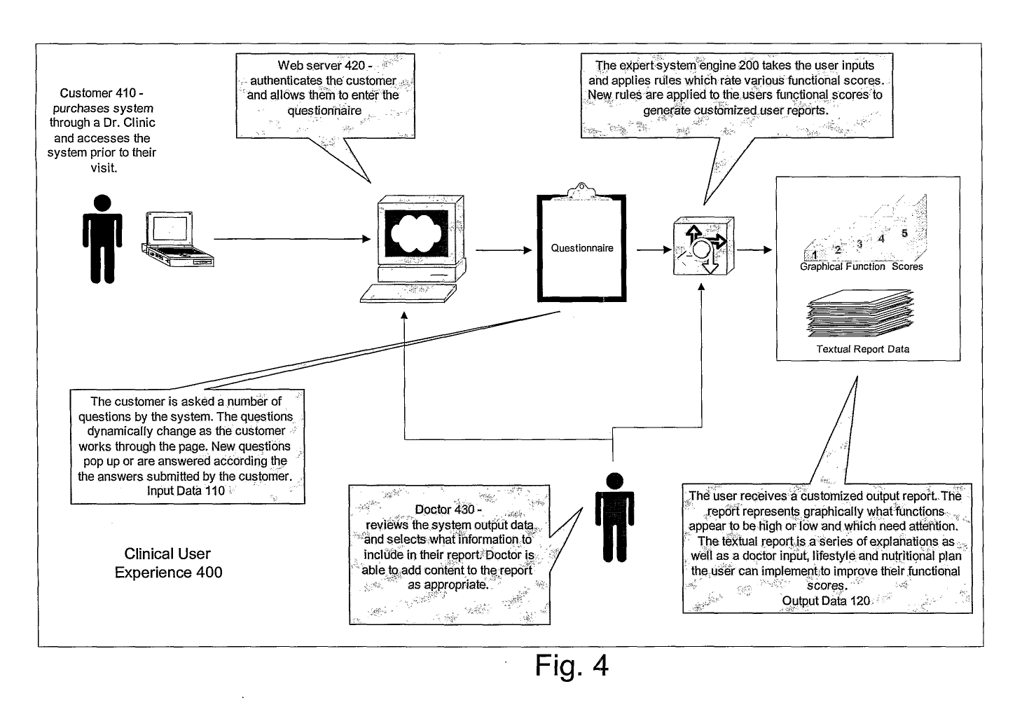

FIG. 4 shows a visual overview of a representative clinical user experience when utilizing the another embodiment of the present invention. Customer 410 may purchase access to the system from a doctor's clinic or office and receive a user name and password that allows the user to connect via a secure socket connection to web server 420. Similar to the direct consumer experience 300 in FIG. 3, the user is presented with a dynamically changing questionnaire. Answers to the questionnaire become input data 110, and the input data 110 is transformed by the expert system engine 200 to create output data 120. However, in this embodiment, a doctor 430 with an associated user name and password may also connect via a secure socket connection to add additional input data 110 and/or access the user's output data 120 to approve and/or modify the output data 120 prior to compiling a report for the user. The report is presented to the user in the form of an online report displayed by the web server 420 over the secure socket connection.

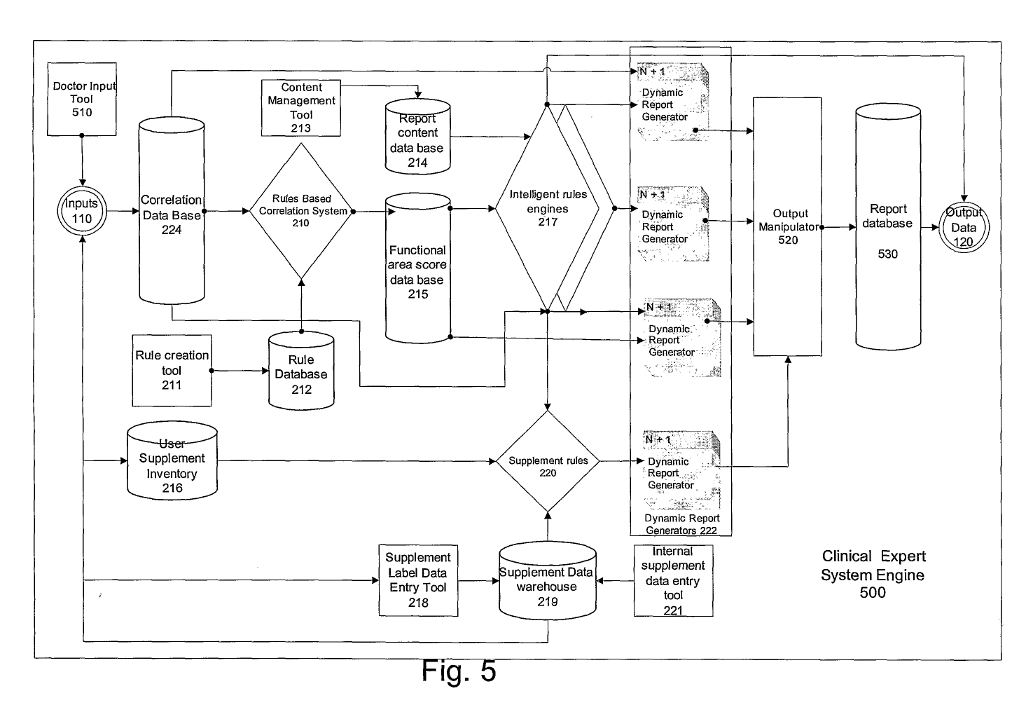

FIG. 5 shows a visual overview of a representative clinical version expert system engine 500 of the present invention. The majority of the components of the clinical version expert system engine 500 are the same as the components above described in expert system engine 200. Thus, the component numbers will remain the same except for the additional components herein described.

The clinical version expert system engine 500 differs from the expert system engine 200 at the places where a physician interfaces. A doctor input tool 510 allows the physician to enter additional information into the input data 110. The information may include data such as laboratory data, diagnosis data, and physical evaluation data. The additional information provided by the doctor is stored in the correlation data base 224 and is utilized as input data 110 similar to the expert system engine 200.

An output manipulator 520 is utilized by the user's doctor to further customize the output data 120 for the user. The output manipulator 520 is accessed by the doctor using a secure socket connection through the web server 420. Using the output manipulator 520, the doctor can select what content data is be presented to the user. For sample, the doctor may decide not to present the user with certain diet or exercise plan because of physical constraints that were observed while evaluating the patient. The doctor is also able to add additional content to the users report via the output manipulator 520. For example, a prescription or other information may be added by the doctor. The information can then be added and stored in the user's report.

The report database 530 stores the modified output data 120 in viewable and printable forms for future reference by the user or the doctor. The output data 120 is also stored in raw data form to be used for trend analyzes and dynamic adjustments to the expert system engine and to create a customized user experience for future user interactions. Unlike in the direct customer experience 300 where the reports are dynamically generated for the user each time the user accesses the report, the content of the clinical user's reports are stored in viewable and printable form for the user and doctor to access.

It will be apparent to those skilled in the art that various modifications and variations can be made in the individualized health evaluation system and method of the present invention without departing form the spirit or scope of the invention. Thus, it is intended that the present invention cover the modifications and variations of the invention provided they come within the scope of the appended claims and their equivalents.

1. A method for creation of science-based individualized life plans comprising:
accessing a secure website;
entering data through the website into a correlation database;
applying correlation rules to the data stored in the correlation database to obtain functional area scores;
outputting the functional area scores into a functional area score database for storage;
applying intelligent rules to the functional area scores stored in the functional area score database;
retrieving content data from a report content database based upon the application of the intelligent rules;
sending the content data to a plurality of dynamic report generators for creation of content specific reports;
dynamically assembling the plurality of content specific reports for viewing.

2. The method according to claim 1, wherein the step of accessing comprises accessing a socket of a secure encrypted server.

3. The method of claim 1, wherein the step of entering data is based upon queries by the website.

4. The method according to claim 1, wherein the correlation rules are stored in a correlation rules database and are input by an administrator using a correlation rule creation tool.

5. The method according to claim 1, wherein the correlation rules are weighted and prioritized by the administrator using a correlation rule creation tool.

6. The method according to claim 1, wherein the content data for the report content database are input by an administrator using a content management tool.

7. The method according to claim 1, wherein medical data may be entered by a medical professional into the correlation database.

8. The method according to claim 1, further comprising.
accessing the plurality of dynamic report generators by a medical professional;
editing the generated content specific reports; and
adding medical data for inclusion in the science-based individualized life plans.

9. The method according to claim 1, wherein the step of assembling also comprises storing the plurality of content specific reports into a report database.

10. The method according to claim 1, further comprising:
entering supplement inventory data by a first individual for entry into a supplement database;
entering supplement data into the supplement database by the first individual using a supplement label data entry tool;
entering supplement data into the supplement database by an administrator using a supplement data entry tool;
applying supplement rules to the data stored in the supplement database to obtain nutrient data based upon the entered supplement inventory data and application of the supplement rules;
sending the nutrient data to the dynamic report generator for creation of a supplement report; and
dynamically assembling the supplement report for viewing.

11. The method according to claim 10, wherein the step of assembling also comprises storing the plurality of content specific reports and the supplement report into a report database.

12. The method according to claim 3, further comprising:
performing a historical trend analysis based upon data in the correlation database, the functional area scores, and content specific reports; and
dynamically adjusting queries sent from the website based upon the historical trend analysis.

13. The method according to claim 12, wherein the historical trend analysis is initiated for health factors identified outside a predicted norm for an individual.

14. An individualized health evaluation system comprising:
a computer;
a memory accessible by the computer;
a file stored in the memory and including personal data as profiles for a first individual;
an interface device for accessing the file by the first individual; and
an expert evaluation application applying correlation rules to the personal data and subsequently applying intelligent rules for determining life plans of the first individual.

15. The system according to claim 14, wherein the interface device includes accessing the file and storing medical data by a set of second individuals associated with the first individual; and
wherein the expert evaluation application also applies correlation rules to the medical data.

16. The system according to claim 15, wherein the computer is a network server computer.

17. The system according to claim 15, wherein the expert evaluation application takes the first individual profiles and applies a first rules based correlation system to apply a set of first rules against the profiles to create a plurality of functional area scores, and a second rules based system to apply a set of second rules against the plurality of functional area scores in order to retrieve content data for use in a report.

18. The system according to claim 15, wherein additional intelligent rules may be dynamically layered upon the outcome of previous rules applied to data.

19. The system according to claim 15, wherein the interface device comprises an electronic connection between the first individual and the system computer.

20. The system according to claim 15, wherein the interface device comprises an electronic connection between the set of second individuals and the system computer.

21. The system according to claim 19, wherein the electronic connection comprises a second computer and a network connection.

22. The system according to claim 19, wherein the electronic connection comprises a wireless device for accessing the Internet.

23. The system according to claim 16, wherein the first individual has a first privileged level of server access and each of the set of second individuals has a respective privileged level of access to the first file, each respective level of access being based on a relationship between respective ones of the second set of individuals and the first individual.

24. The system according to claim 16, wherein the system memory includes one or more query files, and wherein a software application in the server generates query sets from one or more query files for at least one of the first individual and the set of second individuals, and responses to the query sets are stored in the computer memory.

25. The system according to claim 24, wherein the profiles stored in the system memory correspond to query responses provided by at least one of the first individual and the set of second individuals.

26. The system according to claim 17, wherein the content data is processed by a plurality of dynamic report generators to create the report.

27. The system according to claim 20, wherein the electronic connection comprises a second computer and a network connection.

28. The system according to claim 20, wherein the electronic connection comprises a wireless device for accessing the Internet.
